(19) United States
(12) Patent Application Publication
(10) Pub. No.: US 2022/0058590 A1
(43) Pub. Date: Feb. 24, 2022

(54) EQUIPMENT MAINTENANCE IN GEO-DISTRIBUTED EQUIPMENT

(71) Applicant: International Business Machines Corporation, Armonk, NY (US)

(72) Inventors: Dung Tien Phan, PLEASANTVILLE, NY (US); Anuradha Bhamidipaty, Yorktown Heights, NY (US); Bhanukiran Vinzamuri, ELMSFORD, NY (US)

(21) Appl. No.: 16/998,486

(22) Filed: Aug. 20, 2020

(51) Int. Cl. G06Q 10/00; H04W 4/35; H04W 4/029; G06Q 10/06

(52) U.S. Cl. CPC G06Q 10/20; H04W 4/35; G06Q 10/06312; G06Q 10/063116; H04W 4/029

(57) ABSTRACT

A computer-implemented method for maintaining equipment in a geo-distributed system includes receiving, by a processor, a selection of quantities to optimize when adjusting a maintenance schedule of the geo-distributed system that includes multiple pieces of equipment that are spread over a geographical region, and wherein the maintenance schedule identifies when a set of maintenance tasks are executed at a first equipment from the geo-distributed system over a predetermined duration. The method further includes generating, by the processor, a mixed-integer linear program for optimizing the maintenance schedule using a set of predetermined constraints. The method further includes executing, by the processor, the mixed-integer linear program via a mixed-integer linear program solver. The method further includes adjusting, by the processor, the maintenance schedule by selecting only a subset of the maintenance tasks.

### BACKGROUND

The present invention generally relates to industrial equipment, and more specifically, to maintaining over a time horizon a fleet of assets in a geo-distributed network of industrial equipment using a condition-based maintenance schedule.

Various organizations operate businesses that use and depend on a geo-distributed network. For example, water and power utilities, transportation operators, hotels, oil and gas companies, power plants, etc., have a geo-distributed network of equipment that have to be relied upon to operate their respective business. One of the most significant components of their operating cost tends to be maintenance.

In case of large geo-distributed industrial systems and in the case of services that rely on such geographically distributed equipment, it is crucial to determine when to perform a preventive maintenance and a replacement for each equipment in the system. Presently available solutions, typically, use a time-based scheduling for preventive maintenance, or sometimes, use a manual approach where a user decides to perform a preventive maintenance based on his/her experience. This approach, while leveraging human experience, does not fully involve historical and sensor data sources to inform the decision making around these efforts, and can be unpredictable as well as inefficient.

### SUMMARY

A computer-implemented method for maintaining equipment in a geo-distributed system includes receiving, by a processor, a selection of quantities to optimize when adjusting a maintenance schedule of the geo-distributed system that includes multiple pieces of equipment that are spread over a geographical region, and wherein the maintenance schedule identifies when a set of maintenance tasks are executed at a first equipment from the geo-distributed system over a predetermined duration. The method further includes generating, by the processor, a mixed-integer linear program for optimizing the maintenance schedule using a set of predetermined constraints. The method further includes executing, by the processor, the mixed-integer linear program via a mixed-integer linear program solver. The method further includes adjusting, by the processor, the maintenance schedule by selecting only a subset of the maintenance tasks.

In one or more embodiments of the present invention, adjusting the maintenance schedule further includes changing the day on which at least one of the maintenance tasks is performed at the first equipment.

In one or more embodiments of the present invention, the predetermined constraints include a specified budget for maintaining the first equipment. Alternatively, or in addition, the predetermined constraints include an availability of maintenance technician(s) to perform the maintenance tasks. Alternatively, or in addition, the predetermined constraints include an unavailability of the first equipment for performing the maintenance tasks.

In one or more embodiments of the present invention, generating the mixed-integer linear program includes combining one or more of the predetermined constraints and using user input values as thresholds for the predetermined constraints.

The method can further include computing, by the processor, a risk index for the first equipment. The method can further include determining, by the processor, a list of tasks for the first equipment, and generating, by the processor, the maintenance schedule including the list of tasks.

In one or more embodiments of the present invention, the geo-distributed system is a utility provision grid.

In one or more embodiments of the present invention, a system includes a memory having computer readable instructions, and one or more processors for executing the computer readable instructions. The computer readable instructions control the one or more processors to perform operations for maintaining equipment in a geo-distributed system.

In one or more embodiments of the present invention, a computer program product including a computer readable storage medium having program instructions embodied therewith, the program instructions executable by one or more processors to cause the one or more processors to perform operations for maintaining equipment in a geo-distributed system.

Other embodiments of the present invention implement features of the above-described method in computer systems and computer program products.

Embodiments of the present invention provide a preventive maintenance for equipment to help to gain better availability, utilization, and performance. In case of large geo-distributed industrial systems, such as utility grids for electricity, water, telecommunications, and other such services that rely on geographically distributed equipment, it is crucial to determine when to perform a preventive maintenance and a replacement for each equipment in the system. Embodiments of the present invention improve the existing methods for performing such preventive maintenance, which is performed in a time-based manner, or an ad-hoc manner based on human judgment. Embodiments of the present invention generate and optimize a maintenance plan based on a failure analysis of the entire geo-distributed network system (without partitioning the system), where the failure analysis exploits different data sources and models such as electrical connectivity models, asset data, customer data, and external data, and combinations thereof. One or more embodiments of the present invention handle the big data associated with the failure analysis of the large-scale system.

One or more embodiments of the present invention determine risk index for each equipment. Further, one or more embodiments of the present invention use the risk index and geographical information as inputs to optimize a maintenance schedule of the equipment. The optimization is based on several operational constraints including, budget, availability of labor and parts, unavailability of the equipment, externalized tasks, and non-externalized tasks. In one or more embodiments of the present invention, the optimization is based on a scalable optimization model based on mixed-integer linear programming.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example annual electricity outage duration;

FIG. 2 depicts a block diagram of a system for determining a maintenance schedule for a geo-distributed network according to one or more embodiments of the present invention;

FIG. 3 depicts a flowchart of a method for equipment maintenance in geo-distributed network according to one or more embodiments of the present invention;

FIG. 4 depicts a block diagram for computing risk index for an equipment according to one or more embodiments of the present invention;

FIG. 5 depicts a block diagram representing the optimization of the maintenance schedule according to one or more embodiments of the present invention;

FIG. 6 depicts a flowchart for optimizing the maintenance schedule using one or more embodiments of the present invention;

FIG. 7 depicts an example maintenance schedule according to one or more embodiments of the present invention;

FIG. 8 depicts a computer system that implements one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

Embodiments of the present invention facilitate determining a maintenance schedule for a set of equipment (or assets) in a geo-distributed network. In one or more embodiments of the present invention, the maintenance schedule optimizes capital allocation and operational expenses while maintaining availability level in a geo-distributed system.

Presently available solutions to the technical problem of maintaining the equipment use a time-based scheduling for preventive maintenance, or sometimes uses a manual approach where a user decides to perform a preventive maintenance based on his/her experience. This approach, while leveraging human experience, does not fully involve historical and sensor data sources to inform the decision making around these efforts, and can be unpredictable as well as inefficient.

Embodiments of the present invention address such technical challenges and deficiencies in the available solutions. In one or more embodiments of the present invention, a maintenance scheduling system receives and analyzes sensor data about a set of physical assets, i.e., equipment of the geo-distributed network. The analysis facilitates to predict maintenance requirements for each of the equipment. Further, the maintenance scheduling system determines one or more constraints with performing maintenance tasks on the equipment. For example, the constraints can include budgetary limits, technician holidays, effects of equipment downtime, and such. The maintenance scheduling system further uses historical sensor data to predict maintenance requirements for the equipment. Based on the available sensor data, historical sensor data, and imposed constraints, the maintenance scheduling system generates a maintenance plan for the entire geo-distributed network.

The number of monitored and managed assets in a geo-distributed network is typically very large, for example, more than 400,000 equipment. Further, the area covered by the geo-distributed network can also be very large, for example, over 200,000 square miles and more. A geo-distributed network of such scale has an enormous number of dependencies and interactions between the assets. Accordingly, analyzing such big data that includes sensor data, historical data, and constraints data associated with such a geo-distributed network manually is impractical and inefficient. Embodiments of the present invention facilitates analyzing such big data and minimizing unscheduled downtime of equipment in the geo-distributed network due to failure.

Embodiments of the invention will now be described using a geo-distributed network for an electricity distribution network, although the technical features described herein can be applicable to any other type of geo-distributed networks, such as water distribution, oil-and-gas distribution, telecommunications network, franchise locations, etc.

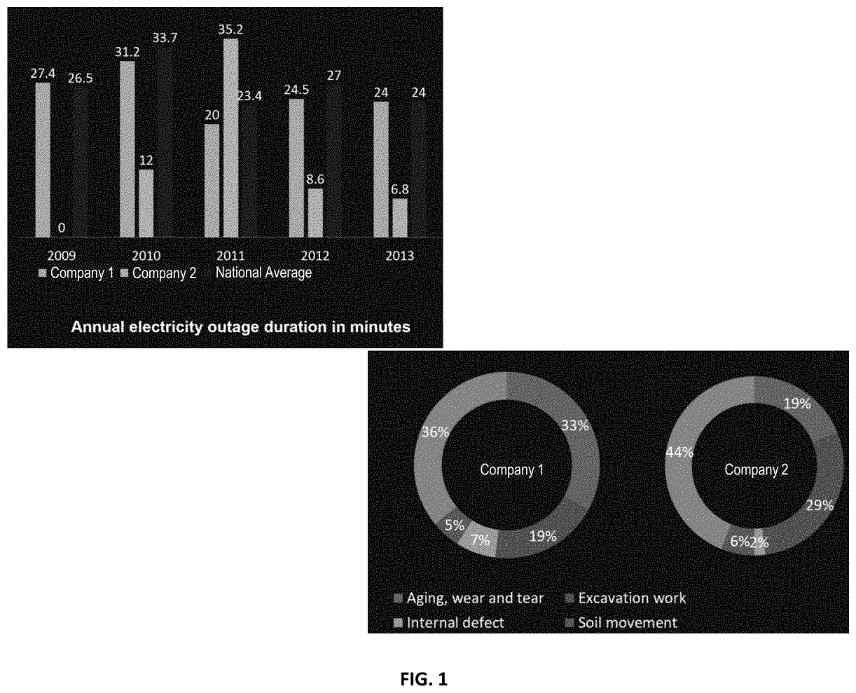

With rapidly rising share of renewable energy sources as well as the increase in the use of electricity, for example, with electric vehicles, maintaining equipment of the electricity distribution network proactively has become increasingly important. The renewable energy sources can cause an uncertainty in amount of electricity generated. The use of electric vehicles and other devices has increased the variation in demand for electricity, particularly, at specific locations. Electricity outages can be caused due to various reasons associated with the equipment like aging, wear and tear, internal defects, excavation work, soil movement, etc. Over several number of years, even with larger investments in equipment maintenance, the annual electricity outage duration has not reduced, as seen in FIG. 1.

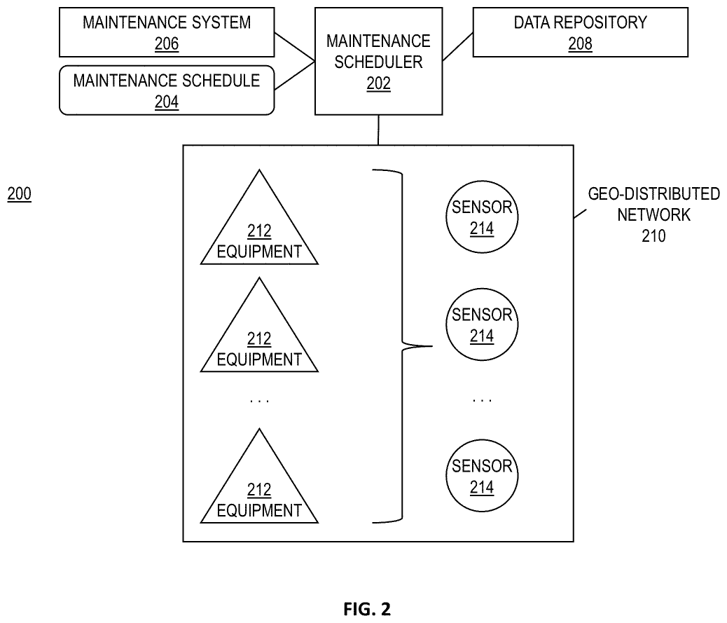

FIG. 2 depicts a block diagram of a system for determining a maintenance schedule for a geo-distributed network according to one or more embodiments of the present invention. The system 200 includes a maintenance scheduler 202 that generates a maintenance schedule 204 for a geo-distributed network 210. In one or more embodiments of the present invention, the maintenance scheduler 202 sends the maintenance schedule 204 to a maintenance system 206 for implementation.

The geo-distributed network 210 includes multiple equipment 212 that has to be maintained. For example, the equipment 212 can include cables, towers, metering units, pipes, fire hydrants, drainage units, etc.

The maintenance scheduler 202 can be a computer system that receives sensor data from one or more sensors 214. The sensors 214 are associated with the equipment 212 from the geo-distributed network 210. The association can be one-to-one, many-to-one, or one-to-many. For example, a first sensor from the sensors 214 can provide data for only one of the assets from the equipment 212; a second sensor from the sensors 214 can provide data for multiple assets from the equipment 212. In yet another case, data for an asset from the equipment 212 has to be collected using multiple sensors from the sensors 214. The sensors 214 can include virtually any type of sensor capable of capturing information and attributes of the equipment 212 to support generation of the maintenance schedule 204. For example, the sensors 214 can include thermometers, gyroscopes, voltmeters, multimeter, ammeter, galvanometer, wattmeter, water sensor, pressure sensor, photosensor, and any other sensor that can provide one or more attribute measurements.

The maintenance scheduler 202 generates the maintenance schedule 204 based on sensor data that it receives from the geo-distributed network 210. Alternatively, or in addition, the maintenance scheduler 202 accesses data from a data repository 208 to generate the maintenance schedule 204.

The data repository 208 includes a data storage device. The data repository 208 stores historical sensor data for the geo-distributed network 210. The data repository 208 further stores one or more constraints about the equipment in the geo-distributed network 210.

In one or more embodiments of the present invention, the data repository 208 can also include a network model of the geo-distributed network 210. For example, the network model can be a graph, tree or any other data structure that provides the interactions and connections between the equipment 212 in the geo-distributed network 210. The data repository 208 can include multiple data sources such as electrical connectivity models, asset data, customer data, and external data to build risk index and impact-action list, also referred to as “needs for action” (NDA) list.

The maintenance schedule 204 can include electronic data, such as a document, table, or any other data structure. The maintenance schedule 204 can include a list of actions for each equipment 212. Each action includes one or more tasks that have to be performed for implementing a maintenance operation of that equipment 212.

The maintenance system 206 can be a computer system that receives the maintenance schedule 204. The maintenance system 206 can be responsible for performing maintenance tasks on the one or more equipment 212 in the geo-distributed network 210. In one or more embodiments of the present invention, the maintenance system 206 can send notifications to one or more technicians to perform one or more tasks to perform maintenance on the equipment 212. The notification can include a time, location, equipment identification, and task identification and procedure. In one or more embodiments of the present invention, the maintenance system 206 can be a portable device, such as a phone, that is associated with a particular technician.

The maintenance scheduler 202 can generate the maintenance schedule 204 using a mixed-integer linear program (MILP) to optimize maintenance planning for the assets 212 of the geo-distributed network 210. According to one or more embodiments of the present invention, the maintenance scheduler 202 computes a risk index for each equipment 212 in the network 210, based on the equipment's probability of failure and its criticality. A mixed-integer programming (MIP) problem is one where the decision variables are constrained to be integer values (i.e. whole numbers such as −1, 0, 1, 2, etc.) at the optimal solution. Linear programming is a set of techniques used to solve systems of linear equations and inequalities while maximizing or minimizing some linear function. MILP is an extension of linear programming. It handles problems in which at least one variable takes a discrete integer rather than a continuous value. MILP facilitates overcoming limitations of linear programming by approximating non-linear functions with piecewise linear functions, using semi-continuous variables, modeling logical constraints, etc. The MILP solver (not shown) can be a set of computer executable instructions, and/or hardware module that the maintenance scheduler 202 uses to execute one or more target functions. In one or more embodiments of the present invention, the MILP solver can be accessed using an application programming interface (API) or any other suitable interface that the MILP solver provides. For example, the MILP solver can be computer programming libraries available with SAS®, MATLAB®, PYTHON®, etc.

The risk index (e.g., ranging from 0 to 100) represents how likely and impactful a failure in each particular equipment 212 is, and provides a measurable way to prioritize the maintenance of that equipment 212.

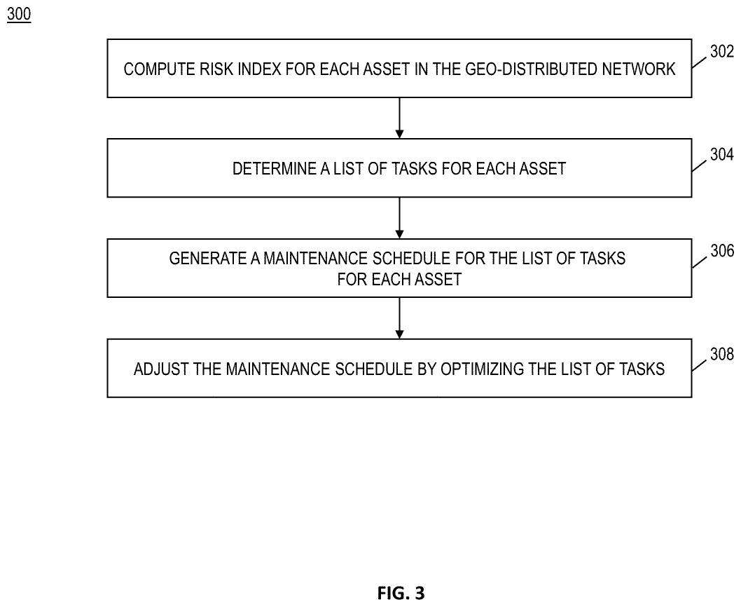

FIG. 3 depicts a flowchart of a method for equipment maintenance in geo-distributed network according to one or more embodiments of the present invention. The method 300 includes computing a risk index for each equipment 212 in the geo-distributed network 210 at a predetermined frequency, at block 302. For example, the risk index can be computed daily for each equipment 212, in one or more embodiments of the present invention. It is understood that in other embodiments, the frequency of computing the risk index can be varied.

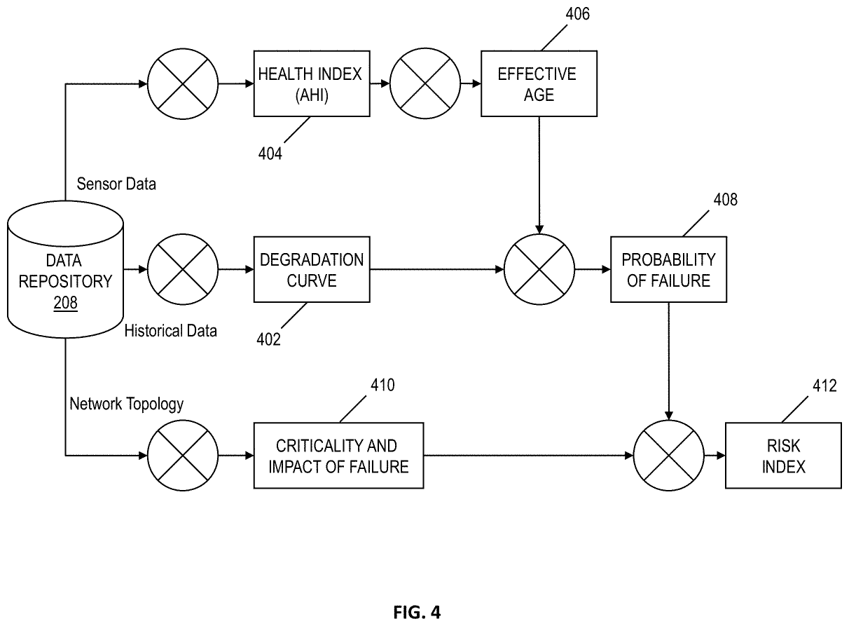

FIG. 4 depicts a block diagram for computing risk index for an equipment according to one or more embodiments of the present invention. Determining the risk index of an equipment E is performed based on the data available for E from the data repository 208. The data for E can include the present sensor data from the sensors 214 that are associated with E, the historical sensor and performance data of E, and a network topology of the geo-distributed network 210. Computing the risk index includes using virtual instrumentation through analytic modeling and simulation to improve visibility into asset health conditions. The data for E can be analyzed using machine learning, such as using artificial neural networks, or other machine learning algorithms, to predict the risk index for each equipment 212.

In the example shown in FIG. 4, the historical data for E is used to model a degradation curve, at block 402. The degradation curve is a graph of the equipment E's condition or remaining service potential plotted over time. Further, using the sensor data from the sensors 214 of E, an asset health index (AHI) is determined, at block 404. The AHI is an asset score that outlines the condition and likely performance of the equipment E based on parameters such as condition risk, using predictive analytics. The index facilitates comparing health of E with a predetermined baseline for the equipment E. The comparison of the AHI and the predetermined baseline provides an effective age of E, at block 406. The effective age is subsequently compared with the degradation curve to determine a probability of failure of E.

A criticality and impact of the failure of E is determined, at block 410, based on the network topology. The criticality and impact of the failure can indicate other equipment 212 that can be rendered unusable because of the failure in E. For example, if E is a power transformer at a node A1, the failure at E can cause all of the equipment that draws power from E can be rendered unusable. It should be noted that the criticality and failure of E can be a predetermined value.

Using the probability of failure, and the criticality and impact of failure, the risk index is computed, at block 412. The risk index can be computed as a product of the two factors, a weighted product, or any other techniques can be used. As an example, from the criticality and impact of failure, a severity can be estimated for each asset from four levels: negligible (1), marginal (2), critical (3), catastrophic (4). From the probability of failure, the likelihood of the failure occurring is ranked on a five-point scale: improbable (1), remote (2), occasional (3) probable (4), frequent (5). For an asset with a pair (severity, probability failure)=(3.4), the risk index is the Euclidian distance \sqrt{3²+4²}=5.

In this manner, the risk index for each equipment 212 in the entire geo-distributed network 210 is computed. Referring back to the flowchart in FIG. 3, the method 300 further includes creating a list of tasks for each equipment 212, at block 304. The list of tasks for an equipment 212 includes a series of needs for action (NDAs), which are generated through a set of rules. Each equipment 212 can have a separate set of rules that determines what series of NDAs is to be performed for improving the state of that equipment 212. These NDAs represent actions that can be performed on the equipment 212 that, in general, can have (positive) effect on the risk index of that equipment 212.

The maintenance schedule 204 can be generated for performing the list of tasks, at block 306. The maintenance scheduler 202 can generate the maintenance schedule 204, at this time, according to a prescribed procedure associated with the list of tasks. For example, the list of tasks can include task T1 and T2, where T2 has to be performed after 2 days since completion of T1; alternatively, T2 has to be performed within 6 hours of T1. It is understood that the list of tasks can include any other number of tasks and that the conditions for implementing the tasks can be different than the examples provided above. The maintenance schedule 204 can include a schedule for all of the equipment 212 for implementing the tasks from the respectively corresponding list of tasks for each of the equipment 212. Alternatively, in one or more embodiments of the present invention, each equipment 212 has a separate maintenance schedule 204.

For carrying out the NDAs from the maintenance schedule 204, and in turn for improving the risk index of the equipment 212, costs have to be incurred such as labor and material costs. The method 300 further includes adjusting the maintenance schedule 204 to find an optimal maintenance policy to improve the total risk/reliability subject to budget and operational constraints by selecting a subset of pre-defined (NDAs), at block 308.

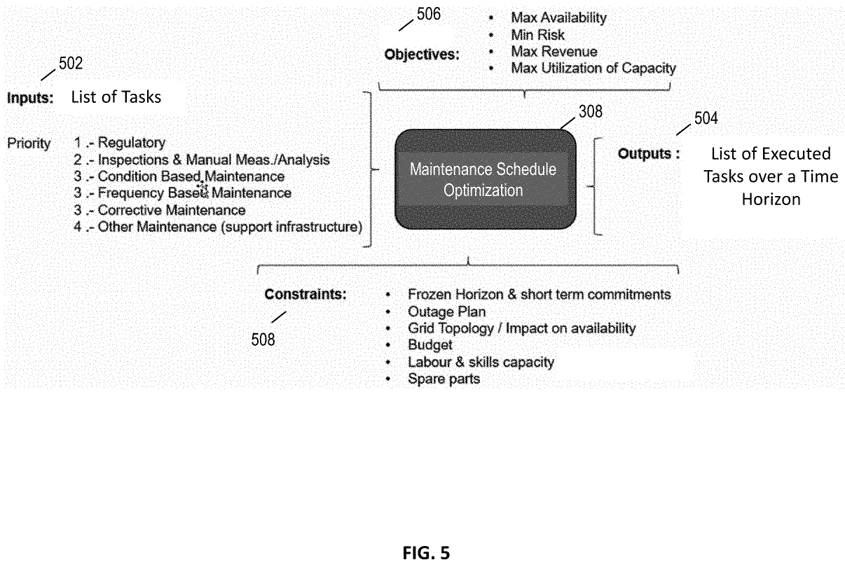

FIG. 5 depicts a block diagram representing the optimization of the maintenance schedule according to one or more embodiments of the present invention. The optimization of the maintenance schedule 204 (at block 308) is based on a set of inputs 502. The inputs 502 include the list of tasks, i.e., the NDAs for the equipment 212. In one or more embodiments of the present invention, the inputs 502 can further include a prioritization of order in which tasks are to be performed. For example, regulatory compliance related tasks may be given highest priority, whereas tasks that are to be performed for supporting the infrastructure in the geo-distributed network 210 from a long-term perspective may be given a lower priority. It is understood that the prioritization example shown in FIG. 5 is one possible set of priorities, and that the prioritization can vary in other embodiments.

Further, the optimization (308) results in outputs 504 that include a grouping of the tasks in a job order, which is sent to the maintenance system 206. The outputs can also include an operation-plan for a predetermined duration in the future, for example, a one-year plan, for the equipment 212. For example, the operation-plan can provide a list of jobs that are to be performed on the equipment 212 over that predetermined duration to maintain the risk index of that equipment 212 at least over the predetermined duration. Further, the outputs can include an outage plan that can result because of the operation-plan of the equipment 212.

The outputs 504 are generate by the maintenance scheduler 202 based on a set of objectives 506. The objectives 506 can include a combination of maximizing availability of the equipment 212, minimizing the risk index of the equipment 212, maximizing revenue associated with the equipment 212, maximizing utilization of capacity of the equipment 212, maximizing safety of the equipment 212, and so on. Depending on the type of the equipment 212, the objectives can vary. For example, the objectives of a power transformer that provides electricity to an industrial complex with heavy machinery may be different than those of a power transformer that provides electricity to domestic neighborhood.

In addition, the maintenance scheduler 202 optimizes the maintenance schedule 204 based on a set of constraints 508. The constraints 508 can include existing commitments of technicians that are required to implement the list of tasks. The constraints 508 can also include an existing outage plan that might affect the equipment 212. For example, an outage plan of another equipment E2 can affect when one or more jobs can be performed on the equipment E because, E may be downstream from E2 in the geo-distributed network. Here, “downstream” indicates that operations at E2 affect the operations of/at E. The constraints 508 can further include the topology of the geo-distributed network 210, operational budget, labor and skill capacity, availability of parts for the tasks, etc.

For example, the topology of the geo-distributed network 210 can indicate another equipment E3 that may be used to temporarily replace the equipment E while E is being operated on. The budget can imply which of the tasks from the list of tasks may be performed for the equipment E. Availability of parts that are required to perform a task can also limit whether and/or when that task can be performed for the equipment E.

Using the techniques described herein, the maintenance scheduler 202 can optimize (308) the maintenance schedule 204 that was generated (306) using a mixed-integer linear program (MILP). The technical solutions described herein further facilitate the maintenance scheduler 202 to make use of geospatial data such as network topology and dependency/relationship for deciding which maintenance tasks to perform, and when to perform such maintenance tasks. The technical solutions described herein further facilitate taking into account the temporal orders/restrictions of maintenance tasks. For example, a task with a higher risk improvement is executed earlier. The maintenance scheduler 202 also takes into account that network availability duration depends on the time point for each task. The maintenance scheduler 202 can further use business/operational/economic constraints to adjust the maintenance schedule 204. Further yet, the maintenance scheduler 202 optimizes the maintenance schedule 204 using a model that is scalable because all restrictions/constraints that the maintenance scheduler enforces are linear.

The maintenance scheduler 202 can adjust at least five quantities: cost (C), risk improvement (R), the number of externalized tasks (E), the number of not externalized tasks (F), and power unavailability (I). Here, an “externalized task” is a task that is to be performed by an external team (outsourced), versus a non-externalized task that is performed by personnel from the organization itself. This distinction can impact the scheduling as well cost of performing the task, as well as subsequent task that may have to be performed, and in turn availability of the equipment 212. The optimizations can be performed at different geography-based levels in the geo-distributed network 210. The entire network 210 is divided into disjoint smaller subregions. A subregion is called a “bag” or an “area” depending on ways to partition the network. The optimization of the geo-distributed network 210 can be performed on a “global” level, where the entire set of equipment 212 is taken into consideration, without any partitioning of the network 210. The bag-based, or area-based optimization can be performed by dividing the network 210 into separate areas or bags, and only taking the equipment 212 from that subregion (area, bag) into account. The partitioning of the network 210 into these subregions can be performed based on geography, for example, using county-lines, or district-lines as boundaries. Alternatively, or in addition, the partitioning can be based on the type of equipment. For example, a first bag can include all metering units, whereas a second bag can include all power transmission towers, and so on. It can be understood that the partitioning of the equipment 212 in the network 210 can be performed in several different ways, other than those described herein.

The optimization of the maintenance schedule 204 can be formulated based on at least three entities—list of tasks, list of unavailability, equipment in each subregion. The formulation of the optimization problem and the description of the solution to the same is now described using the following notation for the sets:
[symbol] : set of tasks
[symbol] : set of clays executing the tasks
[symbol] : set of equipment
[symbol] : set of areas
[symbol] : set of bags

The variables used in the formulation and solution are:

xᵢⱼ=1 if task i is initially used on the j^{th} day;=0 otherwise (iϵ [symbol] , jϵ [symbol] );
zᵢⱼ=1 if task i is initially externalized on the j^{th} day;=0 otherwise (iϵ [symbol] , jϵ [symbol] );
yₖⱼ=1 if equipment k is unavailable on the j^{th} day clue to at least one task; =0 otherwise (kϵ [symbol] , jϵ [symbol] );
EQP_TO_TASKS(k)=mapping equipment kϵ [symbol] to a set of tasks that make the equipment unavailable;
AREA_TO_TASKS(r)=mapping an area rϵR to a set of tasks;
BAG_TO_TASKS(r)=mapping a bag bϵR to a set of tasks.

Further, the parameters that are used in the formulation and solution are:

cⱼ^{time}=a decreasing vector that gives a higher impact for tasks with the same risk improvement value if it is executed earlier;
αₖ=percentage of inoperability of equipment k;
cᵢ^{m}=the material cost for task i;
cᵢ^{s}=the service cost for task i; and
lᵢ=duration days for task i.

Further yet, the constraints can be specified as:

If zᵢⱼ is externalized, then xᵢⱼ=1

zᵢⱼ≤xᵢⱼ,∀iϵ [symbol] ,jϵ [symbol] . (1)

Equipment k is unavailable on the day j if at least one task is applied to the area affecting the k-th equipment 212.

Σ_{iϵEQP_TO_TASKS(k)}(x_{i,max{1,j-l}_{ᵢ}₊₁+ . . . +x_{i,j})≤|EQP_{TO}_{_{TASK{k}}}|yₖⱼ,∀kϵ [symbol] ,jϵ [symbol] , (2)

yₖⱼ≤Σ_{iϵEQP_TO_TASKS(k)}(x_{i,max{1,j-l}_{ᵢ}₊₁+ . . . +x_{i,j}),∀kϵ [symbol] ,jϵ [symbol] . (3)

For each task, only one deployment can be used.

[symbol]

xᵢⱼ≤1, [symbol] zᵢⱼ≤1,∀iϵ [symbol] . (4)

Total cost (C in eq. (7))

Cₜₒₜₐₗ= [symbol] (xᵢⱼcᵢ^{m}+zᵢⱼcᵢ^{s})= [symbol] (cᵢ^{m} [symbol] x_{i,j}+cᵢ^{s} [symbol] z_{i,j}+). (5)

Total risk improvement

Risk_{Total}= [symbol] cⱼ^{time}xᵢⱼrᵢ. (6)

The maintenance scheduler 202 attempts to maximize the total risk improvement Risk.

Externalized tasks per day and per area

E_{j,r}=Σ_{iϵAREA_TO_TASKS(r)}(z_{i,max{1,j-l}_{ᵢ}_{+1}}+ . . . +z_{i,j}),∀rϵ [symbol] ,jϵ [symbol] . (7)

Not externalized tasks per day and per area

Ē_{j,r}=Σ_{iϵAREA_TO_TASKS(r)}((x_{i,max{1,j-l}_{ᵢ}_{+1}}+ . . . +xᵢⱼ)−(z_{i,max{1,j-l}_{ᵢ}_{+1}}+ . . . +z_{i,j})),∀rϵ [symbol] ,jϵ [symbol] . (8)

Percentage of inoperable geo-distributed network 210 (for example, unavailable power in case the network 210 is an electric grid),

I= [symbol] yₖⱼαₖ. (9)

Additional constraints can be setup. For example, constraints for bags includes one for the cost for each bag bϵ [symbol] :

C_{b}= [symbol] Σ_{iϵBAG_TO_TASKS{b}}(xᵢⱼcᵢ^{m}+zᵢⱼcᵢ^{s}),∀bϵ [symbol] . (10)

The risk improvement for each bag bϵ [symbol] :

R_{b}= [symbol] Σ_{iϵBAG_TO_TASKS{b}}cᵢ^{time}xᵢⱼrᵢ),∀bϵ [symbol] . (11)

Further, as noted earlier, holidays and weekends for power unavailability can be defined as u_{i,j}ϵ [symbol] ₊ by the unavailability duration (in days) for the i-th task when it is initially executed in the j-th day, uᵢ^{max}=max {u_{i,j}:jϵ [symbol] }, and u^{max}=max {uᵢ^{max}:iϵ [symbol] }. Asset k is unavailable on the day j if at least one task is applied to the area affecting the k-th task. The inequalities in Table 1 are used to replace (2) and (3).

```
TABLE 1
for j ϵ [symbol]  do
  for k ϵ [symbol]  do [symbol]
    = 0
    for i ϵ EQP_TO_TASKS {k} do
      for t = 0, . . . , uᵢ^{max} − 1 do
        if u_{i,j-t} ≥ t then [symbol]   x_{i,j-t} makes yₖⱼ unav. if (j − t) + u_{i,j-t} ≥ j [symbol]
          = [symbol]   + x_{i,j-t}
        end if
      end for
    end for [symbol]
    ≤ yₖⱼ * |EQP_TO_TASKS {k}| * u^{max}
    yₖⱼ ≤ [symbol]
  end for
end for
```

Further, set of specific tasks [symbol] cannot be executed on specific days [symbol] .

xᵢⱼ=0,∀(i,j)ϵ( [symbol] ). (12)

Further, [symbol] , . . . , [symbol] are defined as the sets of conflicting tasks, meaning that they cannot be executed at the same time.

[symbol]

xᵢⱼ≤1,∀jϵ [symbol] ,s=1, . . . ,S. (13)

Further, no more than 1 equipment 212 of type X can be unavailable at the same time from a particular region unless they come from the same list of tasks. For this, consider T₁, . . . T_{G} to define the sets containing the equipment of the same type. For any k₁, k₂ϵT_{G}, k₁≠k₂, the maintenance scheduler 202 enforces the following:

yk_{1,j}+yk_{2,j}≤1 for every jϵ [symbol] unless there exists (i, t) satisfying

iϵEQP_TO_TASKS{k₁}∩EQP_TO_TASKS{k₂} (14)

0≤t≤uᵢ^{max}−1 (15)

(j−t)+u_{i,j-t}≥j (16)

x_{i,j-1}=1 (17)

Equivalently, for

$${i}_{1} ∈ {EQP}_{{TO}_{TASKS ( {k}_{1} )}} ⋂ {EQP}_{{TO}_{TASKS ( {k}_{2} )}} , {i}_{1} \neq {i}_{2} ,$$

there must hold:

$$y {k}_{1 , j} + y {k}_{2 , j} \leq 2 - {x}_{{i}_{1 , j - {t}_{1}}} * {x}_{{i}_{2 , j - {t}_{2}}} \qquad ( 18 )$$

for all t₁, t₂ such that 0≤t₁≤uᵢ_{₁}^{max}−1, (j−t₁)+uᵢ_{₁}_{,j-t}_{₁})≥j, 0≤t₂≤uᵢ_{₂}^{max}−1, and (j−t₂)+uᵢ_{₂}_{,j-t}_{₂})≥j, it should be noted that if xᵢ_{₁}_{,j-t}_{₁}=1, then yk_{1,j}=1, and similarly, if xᵢ_{₂}_{,j-t}_{₂}=1, then yk_{2,j}=1. From (18), it follows that if xᵢ_{₁}_{,j-t}_{₁}=xᵢ_{₂}_{,j-t}_{₂}=1 for any pair (i₁, i₂), iᵢ≠i₂, then yk_{1,j}+yk_{2,j}≤1.

The term xᵢ_{₁}_{,j-t}_{₁}*xᵢ_{₂}_{,j-t}_{₂} from eq (18) can be linearized by introducing a binary variable vᵢ_{₁}_{,i}_{₂}_{,t}_{₁}_{,t}_{₂}ϵ{0,1} and the maintenance scheduler 202 enforcing

vᵢ_{₁}_{,i}_{₂}_{,t}_{₁}_{,t}_{₂}_{,j}≤xᵢ_{₁}_{,j-t}_{₁}

vᵢ_{₁}_{,i}_{₂}_{,t}_{₁}_{,t}_{₂}_{,j}≤xᵢ_{₂}_{,j-t}_{₂}

vᵢ_{₁}_{,i}_{₂}_{,t}_{₁}_{,t}_{₂}_{,j}≥xᵢ_{₁}_{,j-t}_{₁}+xᵢ_{₂}_{,j-t}_{₂}−1 (19)

As can be seen, vᵢ_{₁}_{,i}_{₂}_{,t}_{₁}_{,t}_{₂}=xᵢ_{₁}_{,j-t}_{₁}*xᵢ_{₂}_{,j-t}_{₂}. Accordingly, the maintenance scheduler 202 uses the constraints from Table 2 to optimize the maintenance schedule 204,

```
TABLE 2
for g = 1, . . . , G do
  for k₁, k₂ ϵ T_{g}, k₁ ≠ k₂ do
    for j ϵ [symbol]  do
      for i₁ ϵ EQP_TO_TASKS{k₁}, i₂ ϵ EQP_TO_TASKS{k₂},
      i₁ ≠ i₂ do
        for 0 ≤ t₁ ≤ uᵢ_{₁}^{max} − 1,0 ≤ t₂ ≤ uᵢ_{₂}^{max} − 1 do
          if uᵢ_{₁}_{,j-t}_{₁} ≥ t₁ & uᵢ_{₂}_{,j-t}_{₂} ≥ t₂ then
            yₖ_{₁}_{,j} + yₖ_{₂}_{,j} ≤ 2 − vᵢ_{₁}_{,i}_{₂}_{,t}_{₁}_{,t}_{₂}_{,j}
              vᵢ_{₁}_{,i}_{₂}_{,t}_{₁}_{,t}_{₂}_{,j} ≤ xᵢ_{₁}_{,j-t}_{₁}
              vᵢ_{₁}_{,i}_{₂}_{,t}_{₁}_{,t}_{₂}_{,j} ≤ xᵢ_{₂}_{,j-t}_{₂}
              vᵢ_{₁}_{,i}_{₂}_{,t}_{₁}_{,t}_{₂}_{,j} ≥ xᵢ_{₁}_{,j-t}_{₁}+ xᵢ_{₂}_{,j-t2} −1
          end if
        end for
      end for
    end for
  end for
end for
```

Further, another optimization performed by the maintenance scheduler 202 is to reduce the number of times an equipment 212 becomes unavailable. For this optimization, the maintenance scheduler 202 uses new variables e and f in or der to count the number of times an equipment 212 becomes unavailable during the time horizon D. Therefore: eₖ_{ⱼ}=1 if the k-th equipment becomes unavailable on the j-th day due to some task; =0 otherwise. fₖ_{ⱼ}=1 if the k-th equipment becomes unavailable on the j-th day when no more tasks are executed; =0 otherwise. The logical relationship between variables y, e, and f can be expressed as:

$$\begin{matrix} {y}_{kj} - {y}_{k , j - 1} = {e}_{kj} - {f}_{kj} , ∀ k ∈ , j = 2 , … , \vert \vert & ( 21 a ) \\ {e}_{kj} + {f}_{kj} \leq 1 , ∀ k ∈ , j = 1 , … , \vert \vert & ( 21 b ) \\ {e}_{k , 1} = {f}_{k , 1} = 0 , ∀ k ∈ ( should use {\sum }_{k}^{ } {e}_{k , 1} = {\sum }_{k}^{ } {f}_{k , 1} = 0 ) . & ( 21 c )\end{matrix}$$

The number of times an equipment 212 becomes unavailable is:

NUₖ= [symbol] eₖ_{ⱼ} (22)

For fixed set of tasks, very first xᵢ, and yᵢ can be used to model the tasks, and to fix the values used for those tasks.

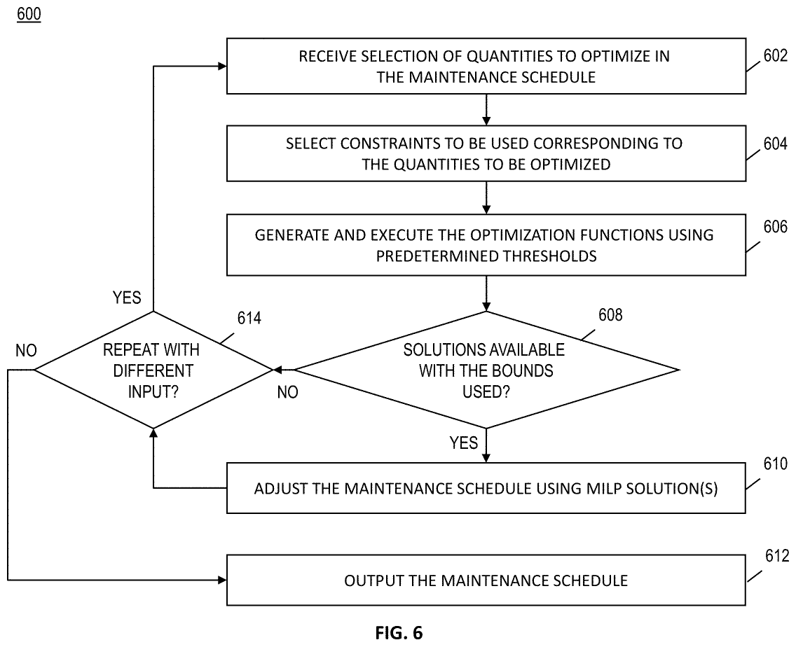

FIG. 6 depicts a flowchart for optimizing the maintenance schedule 204 using one or more constraints according to one or more embodiments of the present invention. The method 600 includes receiving inputs indicating which quantities are to be optimized by adjusting the maintenance schedule 204, at block 602. For example, the maintenance scheduler 202 receives a selection from a user indicating that one or more quantities from among cost (C), risk improvement (R), the number of externalized tasks (E), the number of not externalized tasks (F), and network unavailability (I) is to be optimized.

The maintenance scheduler 202 selects the constraints to be solved using a MILP solver, at block 604. Using a MILP solver, the maintenance scheduler 202 can use the constraints described herein to optimize. Further, the maintenance scheduler 202 generates each quantity in the corresponding target function or the constraint with upper bounds and lower bounds as predetermined thresholds, at block 606. The upper bounds and lower bounds can also be input by the user, in one or more embodiments of the present invention.

For example, the maintenance scheduler 202 can generate and execute a function via the MILP solver to minimize C such that R≥R̅, E≤Ē, F≤F̅, I≤Ī. Here, the symbols with a bar on top represent the predetermined thresholds for those quantities. In this example, the maintenance scheduler 202 minimizes the cost and ensures that the risk improvement (R) is at least a predetermined value, the number of externalized tasks (E) does not exceed a predetermined threshold, the not-externalized tasks (F) is below a predetermined threshold, and also that the unavailability (I) of the geo-distributed network 210 is below a threshold. Here, the threshold for the unavailability can be in the number of days from the time horizon for which the maintenance schedule 204 is generated, for example, next 100 days, next 15 days, next one year, and so on.

In another example, the maintenance scheduler 202 can generate and execute a function via the MILP solver to maximize R such that C≤C̅, E≤Ē, F≤F̅, I≤Ī. Alternatively, or in addition, the maintenance scheduler 202 can generate and execute a function via the MILP solver to maximize R such that C≤C≤C̅, E≤Ē, F≤F̅, I≤Ī. In one or more embodiments of the present invention, the targets can be combined for the maintenance scheduler 202 to generate a function and solve using the MILP solver. For example, the maintenance scheduler 202 minimizes C−R, such that E≤Ē F≤F̅, I≤Ī. In another example, the target function can be to minimize β_{c}C−β_{R}R such that E≤Ē F≤F̅, I≤Ī, where β_{c} and β_{R} are factors provided by the user.

In yet another example, each quantity can be treated at a different level by the maintenance scheduler 202. The entire network 210 is divided into disjoint smaller subregions. A subregion is called a bag or an area. For example, maximize R such that Cₐ≤C̅ₐ, E≤Ē, F≤F̅, I≤Ī, where a is the index for each subregion, i.e., a bag or an area. In this example, the risk improvement is maximized while capping the costs (C) only in the subregion a, while the other bounds for E, F, and I, are for the entire network 210.

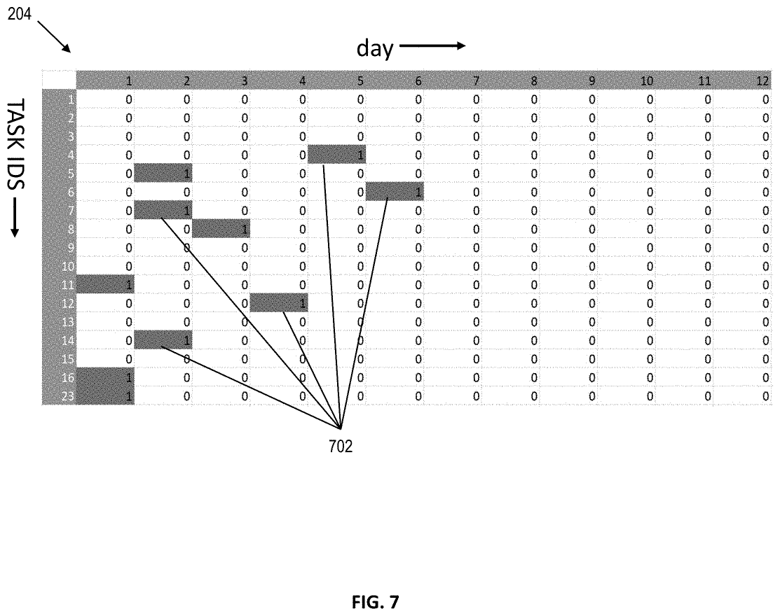

If the maintenance scheduler 202 can solve the generated function using the provided values from the user and other predetermined values, the maintenance scheduler 202 generates an adjusted maintenance schedule 204 using the results of the MILP solution(s), at block 608 and 610. FIG. 7 depicts an example maintenance schedule 204 for one of the equipment 212. Here, each row indicates a task that can be performed for the equipment 212, and each column indicates a day in the duration of the operation-plan. The entries 702 indicate the days on which the maintenance scheduler 202 has planned for the corresponding tasks to be performed to optimize the target quantities. The other entries (with 0s) indicate days on which none of the tasks are to be performed.

The maintenance schedule 204 is output, at block 612. In one or more embodiments of the present invention, the output includes providing the maintenance schedule 204 to the maintenance system 206. Alternatively, or in addition, outputting the maintenance schedule 204 to the user that requested the optimization. If the maintenance schedule 204 is not to the liking of the user, or if the maintenance scheduler 202 was not able to optimize the maintenance schedule 204 (608), the user can provide different input and repeat the method 600, at block 614.

Embodiments of the present invention provide condition-based asset/equipment maintenance planning in geo-distributed networks. Embodiments of the present invention use multiple data sources such as connectivity models, asset data, customer data, and external data to build risk index and impact-action list(s) for each asset at a predetermined frequency. Further, a mixed-integer linear program (MILP) is generated that can be efficiently solved by the MILP solver, where the MILP facilitates optimizing one or more attributes associated with performing one or more maintenance tasks of the equipment. In one or more embodiments of the present invention, the MILP is executed to optimize a maintenance schedule that has been generated for the equipment. The maintenance schedule can be for a predetermined duration and represents one or more maintenance tasks that are scheduled for the equipment over the predetermined duration. The optimization, using the MILP, makes use of geospatial data such network topology and dependency/relationship for the maintenance actions. The optimization also considers the temporal orders/restrictions of the maintenance tasks. In one or more embodiments of the present invention, maintenance tasks with a higher risk improvement are executed earlier. Further, network duration availability depends on the time point at which a maintenance task is performed, and accordingly, the optimization is can consider the availability of the geo-distributed network. Additionally, the optimization can account for business/operational/economic constraints. The optimization model provided herein is scalable because all the restrictions that are used are linear.

Embodiments of the present invention provide a preventive maintenance for equipment to help to gain better availability, utilization, and performance. In case of large geo-distributed network systems, such as utility grids for electricity, water, telecommunications, and other such services that rely on geographically distributed equipment, it is crucial to determine when to perform a preventive maintenance and a replacement for each equipment in the system. Embodiments of the present invention improve the existing methods for performing such preventive maintenance, which is performed in a time-based manner, or an ad-hoc manner based on human judgment. Embodiments of the present invention generate and optimize a maintenance plan based on a failure analysis of the entire geo-distributed network system (without partitioning the system), where the failure analysis exploits different data sources and models such as electrical connectivity models, asset data, customer data, and external data, and combinations thereof. One or more embodiments of the present invention handle the big data associated with the failure analysis of the large-scale system.

One or more embodiments of the present invention determine risk index for each equipment. Further, one or more embodiments of the present invention use the risk index and geographical information as inputs to optimize a maintenance schedule of the equipment. The optimization is based on several operational constraints including, budget, availability of labor and parts, unavailability of the equipment, externalized tasks, and non-externalized tasks. In one or more embodiments of the present invention, the optimization is based on a scalable optimization model based on mixed-integer linear programming.

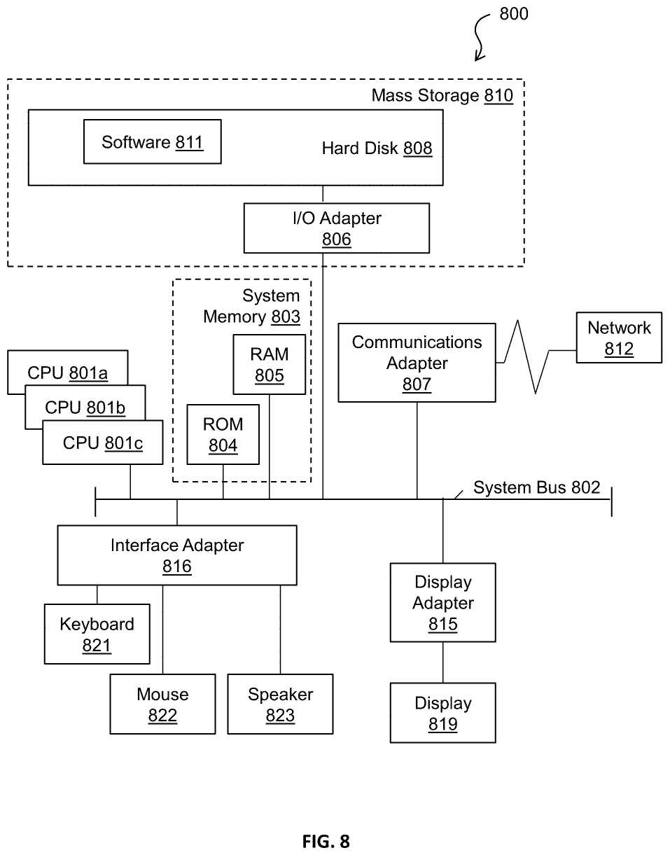

Turning now to FIG. 8, a computer system 800 is generally shown in accordance with an embodiment. The computer system 800 can implement the maintenance scheduler 202 in one or more embodiments of the present invention. The computer system 800 can be an electronic, computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 may be, for example, a server, desktop computer, laptop computer, tablet computer, or smartphone. In some examples, computer system 800 may be a cloud computing node. Computer system 800 may be described in the general context of computer system executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801, also referred to as processing circuits, are coupled via a system bus 802 to a system memory 803 and various other components. The system memory 803 can include a read only memory (ROM) 804 and a random access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read only memory, flash memory, or any other suitable memory systems.

The computer system 800 comprises an input/output (I/O) adapter 806 and a communications adapter 807 coupled to the system bus 802. The I/O adapter 806 may be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described herein below with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one embodiment, a portion of the system memory 803 and the mass storage 810 collectively store an operating system, which may be any appropriate operating system, such as the z/OS or AIX operating system from IBM Corporation, to coordinate the functions of the various components shown in FIG. 8.

Additional input/output devices are shown as connected to the system bus 802 via a display adapter 815 and an interface adapter 816 and. In one embodiment, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics intensive applications and a video controller. A keyboard 821, a mouse 822, a speaker 823, etc. can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and, storage capability including the system memory 803 and the mass storage 810, input means such as the keyboard 821 and the mouse 822, and output capability including the speaker 823 and the display 819.

In some embodiments, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external webserver or a cloud computing node.

It is to be understood that the block diagram of FIG. 8 is not intended to indicate that the computer system 800 is to include all of the components shown in FIG. 8. Rather, the computer system 800 can include any appropriate fewer or additional components not illustrated in FIG. 8 (e.g., additional memory components, embedded controllers, modules, additional network interfaces, etc.). Further, the embodiments described herein with respect to computer system 800 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

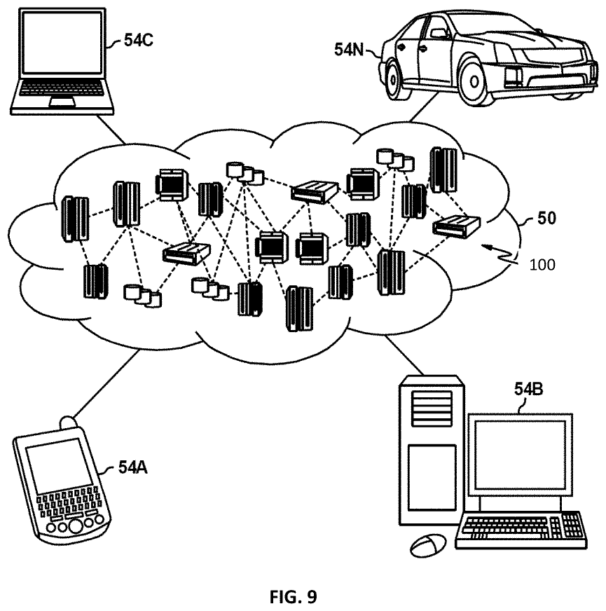

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

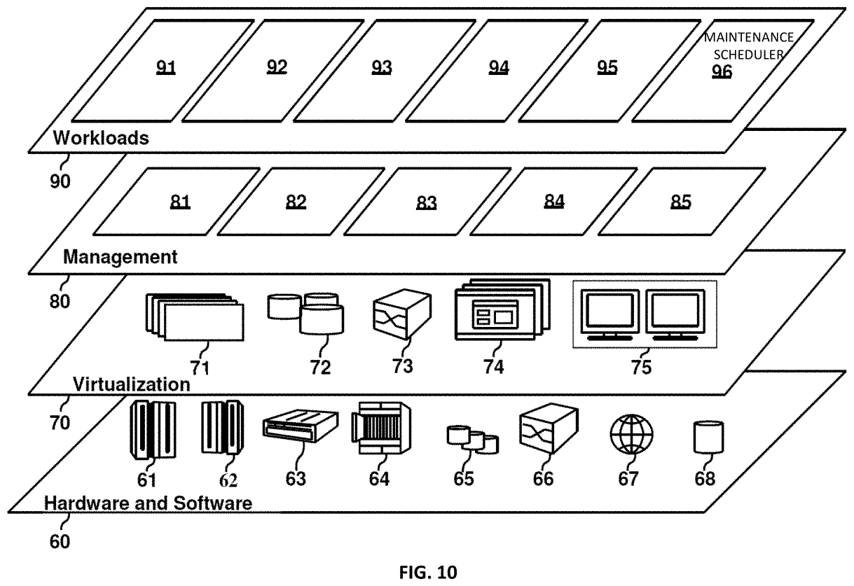

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and maintenance scheduling 96.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for maintaining equipment in a geo-distributed system, the computer-implemented method comprising:
receiving, by a processor, a selection of quantities to adjust a maintenance schedule of the geo-distributed system that includes a plurality of equipment that is spread over a geographical region, and wherein the maintenance schedule identifies when a plurality of maintenance tasks are executed at a first equipment from the geo-distributed system over a predetermined duration;
generating, by the processor, a mixed-integer linear program for adjusting the maintenance schedule using a set of predetermined constraints;
executing, by the processor, the mixed-integer linear program via a mixed-integer linear program solver; and
adjusting, by the processor, the maintenance schedule by selecting only a subset of the maintenance tasks.

2. The computer-implemented method of claim 1, wherein adjusting the maintenance schedule further comprises changing the day on which at least one of the maintenance tasks is performed at the first equipment.

3. The computer-implemented method of claim 1, wherein the predetermined constraints comprise a specified budget for maintaining the first equipment.

4. The computer-implemented method of claim 1, wherein the predetermined constraints comprise an availability of maintenance technician(s) to perform the maintenance tasks.

5. The computer-implemented method of claim 1, wherein the predetermined constraints comprise an unavailability of the first equipment for performing the maintenance tasks.

6. The computer-implemented method of claim 1, wherein generating the mixed-integer linear program comprises combining one or more of the predetermined constraints and using user input values as thresholds for the predetermined constraints.

7. The computer-implemented method of claim 1 further comprising:
computing, by the processor, a risk index for the first equipment;
determining, by the processor, a list of tasks for the first equipment; and
generating, by the processor, the maintenance schedule comprising the list of tasks.

8. The computer-implemented method of claim 1, wherein the geo-distributed system is a utility provision grid.

9. A system comprising:
a memory having computer readable instructions; and
one or more processors for executing the computer readable instructions, the computer readable instructions controlling the one or more processors to perform operations comprising:
receiving a selection of quantities to adjust a maintenance schedule of a geo-distributed system that includes a plurality of equipment that is spread over a geographical region, and wherein the maintenance schedule identifies when a plurality of maintenance tasks are executed at a first equipment from the geo-distributed system over a predetermined duration;
generating a mixed-integer linear program for adjusting the maintenance schedule using a set of predetermined constraints;
executing the mixed-integer linear program via a mixed-integer linear program solver; and
adjusting the maintenance schedule by selecting only a subset of the maintenance tasks.

10. The system of claim 9, wherein adjusting the maintenance schedule further comprises changing the day on which at least one of the maintenance tasks is performed at the first equipment.

11. The system of claim 9, wherein the predetermined constraints comprise a specified budget for maintaining the first equipment.

12. The system of claim 9, wherein the predetermined constraints comprise an availability of maintenance technician(s) to perform the maintenance tasks.

13. The system of claim 9, wherein the predetermined constraints comprise an unavailability of the first equipment for performing the maintenance tasks.

14. The system of claim 9, wherein generating the mixed-integer linear program comprises combining one or more of the predetermined constraints and using user input values as thresholds for the predetermined constraints.

15. The system of claim 9, wherein the computer readable instructions cause the one or more processors to further perform operations comprising:
computing a risk index for the first equipment;
determining a list of tasks for the first equipment; and
generating the maintenance schedule comprising the list of tasks.

16. A computer program product comprising a computer readable storage medium having program instructions embodied therewith, the program instructions executable by one or more processors to cause the one or more processors to perform operations comprising:
receiving a selection of quantities to adjust a maintenance schedule of a geo-distributed system that includes a plurality of equipment that is spread over a geographical region, and wherein the maintenance schedule identifies when a plurality of maintenance tasks are executed at a first equipment from the geo-distributed system over a predetermined duration;
generating a mixed-integer linear program for adjusting the maintenance schedule using a set of predetermined constraints;
executing the mixed-integer linear program via a mixed-integer linear program solver; and
adjusting the maintenance schedule by selecting only a subset of the maintenance tasks.

17. The computer program product of claim 16, wherein adjusting the maintenance schedule further comprises changing the day on which at least one of the maintenance tasks is performed at the first equipment.

18. The computer program product of claim 16, wherein the computer readable instructions cause the one or more processors to further perform operations comprising:
computing a risk index for the first equipment;
determining a list of tasks for the first equipment; and
generating the maintenance schedule comprising the list of tasks.

19. The computer program product of claim 16, wherein the predetermined constraints comprise an availability of maintenance technician(s) to perform the maintenance tasks.

20. The computer program product of claim 16, wherein the predetermined constraints comprise a specified budget for maintaining the first equipment.
